(19) United States
(12) Patent Application Publication
(10) Pub. No.: US 2012/0265513 A1
(43) Pub. Date: Oct. 18, 2012

(54) METHODS AND SYSTEMS FOR DESIGNING STABLE PROTEINS

(76) Inventors: Jianwen Fang, Lawrence, KS (US); Yunqi Li, New Brunswick, NJ (US); C. Russell Middaugh, Lawrence, KS (US)

(21) Appl. No.: 13/442,611

(22) Filed: Apr. 9, 2012

Related U.S. Application Data
(60) Provisional application No. 61/473,611, filed on Apr. 8, 2011.

(51) Int. Cl. G06F 19/12

(52) U.S. Cl. 703/11

(57) ABSTRACT

Methods and computing systems for generating a protein stability lookup table and a predictive model. These methods and systems are useful for predicting the thermal stability of a protein sequence and for predicting mutations that may enhance the thermal stability of a protein given its amino acid sequence and/or three dimensional structure. The protein stability lookup table and a predictive model are based on a combination and analysis of related protein sequences and, where available, protein structure data, and relative stability data from mesophilic and thermophilic organisms and experimentally determined stability changes of wild type proteins and their mutants.

### CROSS-REFERENCE TO RELATED APPLICATIONS

This application claims the benefit of and priority to U.S. Prov. Pat. App. Ser. No. 61/473,611 filed 8 Apr. 2011 and entitled “METHODS FOR DESIGNING STABLE PROTEINS,” the entirety of which is incorporated herein by reference.

### BACKGROUND

It is highly desirable to engineer proteins for stability in order to use them as protein-based drugs or enzymes in bio-technologic or other processes. Proteins are fundamental components necessary for the proper functioning of all organisms. Many human diseases are associated with proteins in our bodies. Due to increasing understanding of our own biological systems and the advances of science and technology, protein-based drugs have become increasingly attractive because of their high efficiency and low side effects. Unfortunately, most native proteins are only marginally stable under normal physiological conditions. Drugs based on these native proteins are often susceptible to physical and chemical degradation that affect potency and safety during manufacturing, transportation, and storage processes. They may not have an appreciable shelf life or need strict cold chain requirements.

Proteins stable at higher temperature are also useful in many biotechnological applications. For example, enzymes stable at higher temperature allow catalyzed chemical reactions performed at higher temperature, which usually lead to more efficient industrial processes because chemical reactions are intrinsically faster at higher temperature, or even allow reactions infeasible at lower temperature.

Current standard approaches for protein stabilization include protein formulations and directed evolution of proteins. The former is labor intensive and time consuming. The later also involves labor-intensive methods and requires expensive processes.

Computational protein design methods are attractive due to their potential cost and time-saving over conventional approaches. In general, these computational methods are attempts to find principles of protein thermo-stability and apply them for rationally designing proteins.

Thermophiles are organisms live under elevated temperatures as high as 122° C. Naturally the proteins produced by thermophiles (thermophilic proteins or TPs) are intrinsically more thermo-stable than their mesophilic counterparts (mesophilic proteins or MPs). Therefore studying the difference between thermophilic and mesophilic proteins may provide key knowledge for designing thermo-stable proteins. Many genomes of these thermophilies have been sequenced and are publicly available for comparative studies. However, existing studies have been focused on statistical analysis of the difference between these two groups of proteins. While such studies have identified overall difference between thermophilic and mesophilic proteins, there has been minimal success in using these differences to predict changes in other proteins that will result in improved thermal stability. There continues to be a long felt and unmet need for methods for accurately predicting changes in proteins that will have a stabilizing effect.

### BRIEF SUMMARY

The present invention includes methods and computing systems for generating a protein stability lookup table and a predictive model. These methods and systems are useful for predicting mutations that may enhance the thermal stability of a protein given its amino acid sequence and/or three-dimensional structure. The protein stability lookup table and a predictive model are based on a combination and analysis of related protein sequences, relative stability data from mesophilic and thermophilic organisms, experimentally determined protein stability changes as a result of mutations among wild type proteins and their mutants, and where available, protein structure data.

The protein stability potential lookup table includes a plurality of sequential terms and, optionally, spatial terms. The sequential and spatial terms are generated by analyzing and mining the sequence and structure data from sequences and structures of mesophilic proteins (“MPs”) and thermophilic proteins (“TPs”), as well as experimentally determined protein stability changes as a result of mutations. The protein stability potential lookup can be used to calculate the terms in the predictive model, which acts as a predictive tool for accurately estimating the relative thermal stability of a protein and/or to propose or determine one or more mutations of a protein that may increase its thermal stability.

The sequential terms are derived for peptide fragments of a selected size in all possible permutations of the 20 naturally occurring amino acids (e.g., 20⁴ or 160,000 permutations of tetrapeptide fragments). The sequential terms are based on (1) a combination and analysis of proteins from mesophilic and thermophilic organisms and (2) a stability dataset of experimentally determined thermo-stability changes among and between wild type proteins and their mutants. Sequential terms are calculated for each of the possible peptide fragments (e.g., 20⁴ tetrapeptide fragments).

Where high-resolution structural data are available for proteins from mesophilic and thermophilic organisms, the spatial terms can be calculated by dividing the structures up into all possible spatial combinations of the 20 naturally occurring amino acids (e.g., the 20 naturally occurring amino acids yields 8855 spatial combinations of four amino acids). These spatial combinations are called Delaunay polygons or Delaunay tetrahedra in the case of four amino acid fragments. The spatial terms are based on (1) a combination and analysis of protein structures from mesophilic and thermophilic organisms and (2) a stability dataset of experimentally determined thermo-stability changes among and between wild type proteins and their mutants. Spatial terms are calculated for each of the possible Delaunay polygons (e.g., 8855 combinations of four amino acids).

In one embodiment, the present invention relates to a method for making software for predicting mutations that stabilize a protein. In this embodiment, the method can include generating a protein stability potential lookup table. The protein stability lookup table can be generated at least in part by (i) providing a first protein database of thermophilic and mesophilic protein sequences, (ii) providing a stability dataset of experimentally determined thermo-stability changes upon mutations for proteins and their mutants, (iii) dividing the thermophilic and mesophilic protein sequences into a series of 20ⁿ peptide fragments, (iv) deriving a plurality of sequential terms for each of the 20ⁿ peptide fragments by combining and analyzing the first protein database and the stability dataset, and (iv) fitting the relative weights of the sequential terms using the stability dataset.

The first protein database and stability dataset may further include structural data for at least a subset of the thermophilic and mesophilic protein sequences in the first protein database and the stability dataset. In such a case, the method further comprises deriving a plurality of spatial terms based on the structural data, and fitting the relative weights of the spatial terms using the stability dataset.

In another embodiment, the present invention relates to a computer system that includes one or more processors, system memory, and one or more computer-readable storage media having stored thereon computer-executable instructions that, when executed by the one or more processors, causes the computing system to perform a method for determining one or more mutations for increasing the thermal stability of a protein. The computer implemented method includes (1) receiving into the computer system an amino acid sequence of a protein to be stabilized, and (2) using a protein stability lookup table and at least one predictive model calculated based on the protein stability lookup table to determine one or more mutations for the peptide sequence that increases the thermal stability of the protein.

In yet a third embodiment, the present invention relates to a method for predicting mutations that increase protein stability. In one embodiment, the method may include: (1) providing a computing system having (i) a protein stability potential lookup table that includes 20⁴ unique peptide fragment sequences each having a thermal stability factor associated therewith and a (ii) predictive model calculated based on the protein stability lookup table, (2) inputting into the computing system an amino acid sequence that defines a base protein, (3) determining a multitude of proposed mutations of the base protein sequence, (4) assigning a relative thermo-stability potential to each of the multitude of proposed mutations based on the protein stability potential lookup table and the predictive model, and (5) outputting from the computing system a mutant protein sequence that defines a mutant protein that is more thermally stable than the base protein, wherein the mutant protein sequence includes a subset of stabilizing mutations selected from the multitude of proposed mutations.

These and other objects and features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only illustrated embodiments of the invention and are therefore not to be considered limiting of its scope. The invention will be described and explained with additional specificity and detail through the use of the accompanying drawings in which:

FIG. 1 illustrates a computing system for generating a protein stability lookup table and a predictive model;

FIG. 2 is a flow chart illustrating a method for generating a protein stability lookup table and a predictive model;

FIG. 3 illustrates a computing system for receiving a peptide sequence of a protein to be stabilized, using a predictive model and a protein stability lookup table to determine one or more mutations for the peptide sequence that increases the thermal stability of the protein generating a protein stability lookup table and a predictive model, and outputting a mutated protein sequence;

FIG. 4 is a flow chart illustrating a method for receiving a peptide sequence of a protein to be stabilized and using a predictive model and a protein stability lookup table to determine one or more mutations for the peptide sequence that increases the thermal stability of the protein generating a protein stability lookup table and a predictive model;

FIG. 5 illustrates a computing system for generating a protein stability lookup table and a predictive model, receiving a peptide sequence of a protein to be stabilized, using the predictive model and the protein stability lookup table to determine one or more mutations for the peptide sequence that increases the thermal stability of the protein, and outputting a mutated protein sequence; and

FIG. 6 is a flow chart illustrating a method for generating a protein stability lookup table and a predictive model, receiving a peptide sequence of a protein to be stabilized, using the predictive model and the protein stability lookup table to determine one or more mutations for the peptide sequence that increases the thermal stability of the protein, and outputting a mutated protein sequence.

### DETAILED DESCRIPTION OF THE INVENTION

The present invention includes methods and computing systems for generating a protein stability lookup table and a predictive model. These methods and systems are useful for predicting mutations that may enhance the thermal stability of a protein given its peptide sequence and/or protein structure. The protein stability lookup table and the predictive model are based on a combination and analysis of related protein sequences, relative stability data from mesophilic and thermophilic organisms, experimentally determined protein stability changes as a result of mutations among wild type proteins and their mutants, and, where available, protein structure data.

The protein stability potential lookup table includes a plurality of sequential terms and, optionally, spatial terms. The sequential and spatial terms are generated by analyzing and mining the sequence and structure data of mesophilic proteins (“MPs”) and thermophilic proteins (“TPs”), as well as experimentally determined protein stability changes as a result of mutations wild type proteins and their mutants. The protein stability potential lookup can be used to calculate the terms in the predictive model, which acts as a predictive tool for accurately estimating the relative thermal stability of a protein and/or to propose or determine one or more mutations of a protein that may increase its thermal stability.

Steps for developing models that can be used in the present invention include: (i) creating a non-redundant dataset of thermophilic and mesophilic protein structure and sequences, (ii) creating a non-redundant dataset of experimentally determined thermo-stability changes upon mutations, (iii) creating a multi-residue-based (e.g., a four-residue) protein stability lookup table, and (iv) formulating a predictive model based on the protein stability lookup table.

In one example, the predictive model is a PROTS predictive model. Formulating the PROTS predictive model includes (i) providing the protein stability lookup table that includes a number of terms relating to sequential and/or spatial potential and propensity (i.e., PROTS terms), (ii) calculating a linear combination the PROTS terms, and (iii) fitting the relative weights of the linear combination of the PROTS terms based on the non-redundant dataset of experimentally determined thermo-stability changes upon mutations. Additional explanation of the formulation of the PROTS model can be found in the Examples included herein.

In another example, the predictive model is a PROTS-RF predictive model. Formulating the PROTS-RF predictive model includes (i) providing the protein stability lookup table that includes the PROTS terms, (ii) combining the PROTS terms with a number of additional terms based on evolutionary information, secondary structure data and solvent accessibility, and relative difference terms (i.e., change of positive charged residues, charged residues, small residues, tiny residues, maximum area of solvent accessibility (ASA) and the iso-electric point (pIa)), and (iii) formulating the PROTS-RF predictive model by refining the combination of the PROTS terms and the additional terms using a Random Forest algorithm to calculate a number of different independent decision trees until no noteworthy improvements are observed. Additional explanation of the formulation of the PROTS-RF model can be found in the Examples included herein.

The present invention is also a process of identifying single or multiple mutations for a given base protein sequence for developing more stable mutants of the base protein without losing its function and activity. The process includes an optional step of generating a list of allowable substitutions, using a PROTS predictive model and/or PROTS-RF predictive model to predict protein stability potential changes of each allowable substitution and select those with greatest increases. PROTS and PROTS-RF can be run independently or jointly (using either Boolean AND or OR operations). The optional step of generating a list of allowable substitutions can be done by comparing the base protein sequence to a large non-redundant protein database using software programs such as BLAST. Well conserved residues are considered important for the protein's function and activity, therefore they are not subjected to mutations. The cutoff level of conservation is changeable and the number of allowable mutations will change accordingly.

The methods can be used to predict the relative thermal stability of proteins better than other algorithms known in the art. The advantages of the methods and computer systems of the present invention are well demonstrated in comparisons of protein thermal stability improvements carried out on test proteins. In test samples, one of two predicted mutations in a known protein based vaccine resulted in a mutant with melting temperature 6.2 degree higher than the wild type vaccine. As comparison, the best of the five mutants predicted using a leading competitive method has melting temperature 1.9 degree higher than the same wild type vaccine.

The methods are broadly applicable to industry and markets for proteins because more stable proteins have longer life span and can be used in elevated temperatures. They can be used in many industries such as pharmaceutical, bioenergy, biomaterials, oil and gas, paper and pulp, etc. The following are some examples of possible applications for proteins with increased thermal stability: Can be applied in developing stable vaccines or other protein based therapeutics which have long shelf life and reduced cold chain requirements; Can be used to improve the stability of industrial enzymes used in biotranformation procedures such as for drug intermediates, biomaterials, etc.; Can be used to stabilize the enzymes used in bioenergy section to convert biomass to clean energy; and/or Can be applied in stabilizing the enzymes used in household products such as detergents, etc.

The methods can predict mutations that may enhance protein stability automatically without human intervention. The data can be imported into a computing system, and the computing system can then predict the mutations to increase stability by processing the data through an algorithm.

The computer program products and methods are sufficiently robust to make accurate predictions for thermal stability based solely on the target protein sequence (i.e., without the structure). When available, the products and methods described herein can also utilize structural data, which may improve the prediction accuracy.

The present invention can also be used to compare the relative stability of any number of proteins (wild types and/or mutants).

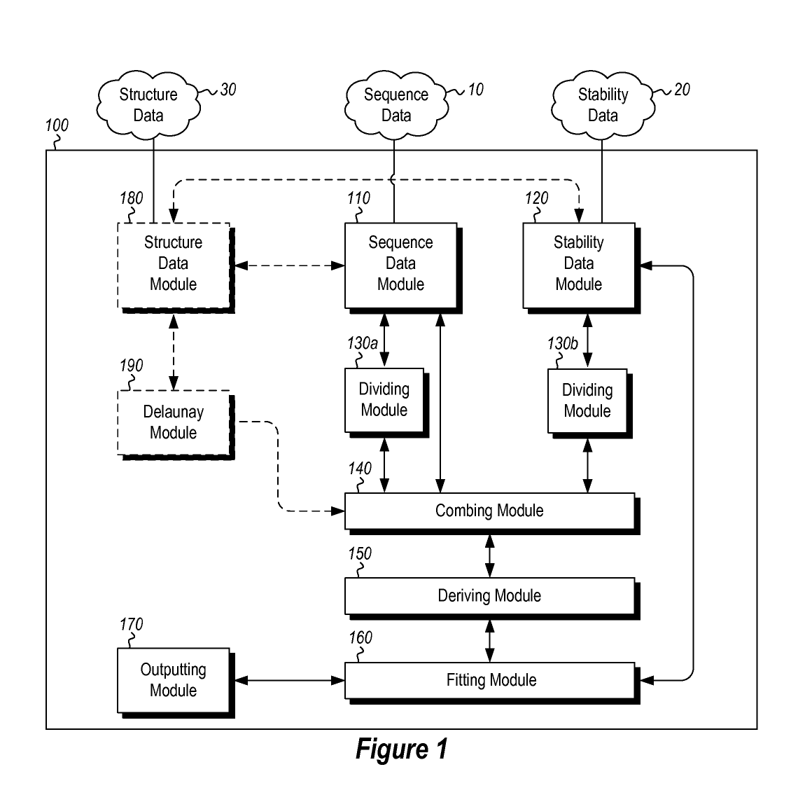

Referring now to FIG. 1, a computing system 100 for making a computer program product for calculating the thermal stability of a protein and/or for predicting mutations that stabilize a protein is illustrated. The computing system 100 includes one or more processors, system memory, and one or more computer-readable storage media having stored thereon computer-executable instructions that, when executed by the one or more processors, causes the computing system to perform a method for making the computer program product for calculating the thermal stability of a protein and/or for predicting mutations that stabilize a protein.

The computing system 100 includes a sequence data module 110 and a stability data module 120. The sequence data module 110 receives protein sequence data for mesophilic and thermophilic organisms from a protein sequence database illustrated at 10. In one embodiment, the protein sequence database 10 includes a non-redundant set of protein sequence data for proteins from mesophilic and thermophilic organisms. The stability data module 120 receives protein stability data from a protein stability database that is illustrated at 20. The protein stability database includes experimentally determined data regarding changes in stability upon mutation.

When sequence data are received by the sequence data module 110, the data are transferred to the dividing module 130a of the computing system 100. The dividing module 130a divides the sequence data into all possible permutations of peptide fragments of a selected size. For example, the dividing module 130a may divide the sequence data into a series of tetrapeptides; there are 20⁴ or 160,000 possible tetrapeptide permutations of the 20 naturally occurring amino acids.

Likewise, when stability data are received by the stability data module 120, the data are transferred to the dividing module 130b of the computing system 100. The dividing module 130b divides the stability data into all possible permutations of peptide fragments of a selected size.

The output of the dividing modules 130a and 130b is combined with the sequence data from the sequence data module 110 and the stability data from the stability data module 120 by the computing system 100 in the combining module 140. In the combining module 140, the data are related to one another and combined into one data set. The output of the combining module is fed to the deriving module 150 of the computing system 100. The task of the deriving module 150 is to derive a set of sequence terms for each of the each of the multi-peptide fragments provided by the dividing module 130. The sequence terms derived by the deriving module 150 consist of 13 sequential features that include seven potential terms and six propensity terms. The seven potential terms are related to occurrence (i.e., the potential that a fragment exits), a set of secondary structural terms that evaluate the potential that a fragment exits in a helix, a strand, or a sheet, and a set of exposure terms that evaluate the potential that a fragment is exposed, buried, or in an intermediate state. The six propensity terms include a set of secondary structural terms that evaluate the likelihood that a fragment exits in a helix, a strand, or a sheet, and a set of exposure terms that evaluate the likelihood that a fragment is exposed, buried, or in an intermediate state. The derived terms are used to construct a sequential protein stability lookup table. The derivation of the potential and propensity terms is explained in greater detail in the Examples included herein.

The sequence terms derived by the deriving module 150 are fed to the fitting module 160 and the weights of the terms are fitted by the computer system 100 and the fitting module 160 by referring back to the stability data module 120. Fitting the data according to the stability data in the stability data module 120 allows determining the relative weights of the terms. The output of the fitting module may be fed to an outputting module 170 that outputs a predictive model that includes the sequential terms and that may be used for calculating the thermal stability of a protein and/or for predicting mutations that stabilize a protein.

An example that includes of the first 20 lines of a protein stability lookup table that includes the 13 sequential terms is shown below as Table 1.

TABLE 1

| Tetrapeptide | psqcount | phelix | Psheet | pcoil | pexp | pbury | pinter |
|---|---|---|---|---|---|---|---|
| GGGG | −0.02356 | 0.00121 | −0.01209 | −0.04226 | −0.05266 | −0.00813 | −0.02196 |
| GGGA | −0.01859 | 0.00610 | −0.01933 | −0.03578 | −0.02597 | −0.01759 | −0.01278 |
| GGGV | −0.00252 | 0.00089 | −0.00156 | −0.00308 | 0.00326 | −0.00767 | 0.00276 |
| GGGL | −0.03201 | −0.01447 | −0.02244 | −0.02373 | −0.01836 | −0.02753 | −0.00776 |
| GGGI | −0.02004 | −0.00776 | −0.02381 | −0.02664 | −0.03049 | −0.02135 | −0.00848 |
| GGGS | −0.01095 | 0.00734 | −0.00817 | −0.02377 | −0.01543 | −0.01079 | −0.00690 |
| GGGT | −0.00224 | −0.00283 | 0.00109 | −0.00189 | −0.00833 | −0.00326 | 0.00572 |
| GGGC | −0.00455 | −0.00665 | −0.00511 | −0.00226 | 0.00000 | −0.00689 | −0.00376 |
| GGGM | −0.00911 | −0.00601 | −0.01021 | −0.01097 | −0.00192 | −0.01355 | −0.00683 |
| GGGP | −0.00823 | 0.00019 | −0.00152 | −0.01546 | −0.01970 | −0.00332 | −0.00776 |
| GGGD | −0.01070 | 0.00081 | −0.00340 | −0.02085 | −0.01115 | −0.00983 | −0.01199 |
| GGGN | −0.01534 | −0.01197 | −0.00245 | −0.02300 | −0.01381 | −0.01406 | −0.01980 |
| GGGE | −0.00340 | 0.01079 | −0.00430 | −0.01112 | −0.00331 | −0.00096 | −0.00769 |
| GGGQ | −0.00615 | 0.00346 | −0.00166 | −0.01445 | −0.01115 | −0.00131 | −0.01159 |
| GGGK | −0.00023 | −0.00042 | 0.00327 | −0.00091 | −0.00798 | −0.00113 | 0.01119 |
| GGGR | 0.00611 | −0.00859 | 0.01673 | 0.00893 | 0.01343 | −0.00093 | 0.00524 |
| GGGH | −0.00141 | −0.00253 | −0.00152 | −0.00006 | 0.01515 | −0.00958 | −0.00320 |
| GGGF | −0.01030 | −0.00280 | 0.00016 | −0.01941 | 0.00716 | −0.02098 | −0.00404 |
| GGGY | −0.01142 | −0.01197 | −0.00825 | −0.01251 | −0.01090 | −0.01180 | −0.01159 |
| GGGW | 0.00267 | 0.00254 | −0.00619 | 0.00708 | −0.00092 | 0.00167 | 0.00852 |

| Tetrapeptide | dhelix | dsheet | dcoil | dexp | dbury | dinter |
|---|---|---|---|---|---|---|
| GGGG | 0.15714 | −0.03929 | −0.11786 | −0.26591 | 0.26006 | 0.00584 |
| GGGA | 0.31985 | −0.08640 | −0.23346 | −0.10662 | 0.02451 | 0.08211 |
| GGGV | 0.03239 | 0.00415 | −0.03654 | 0.04070 | −0.08015 | 0.03945 |
| GGGL | −0.04318 | −0.05455 | 0.09773 | −0.02159 | −0.12500 | 0.14659 |
| GGGI | 0.09302 | −0.09767 | 0.00465 | −0.23837 | 0.10116 | 0.13721 |
| GGGS | 0.19485 | −0.00123 | −0.19363 | −0.06740 | 0.03922 | 0.02819 |
| GGGT | 0.00000 | 0.01738 | −0.01738 | −0.08422 | 0.00334 | 0.08088 |
| GGGC | −0.56250 | −0.25000 | −0.18750 | 0.00000 | −0.81250 | −0.18750 |
| GGGM | −0.15385 | −0.17308 | 0.32692 | 0.15385 | −0.03846 | −0.11538 |
| GGGP | 0.10000 | −0.01000 | −0.09000 | −0.24000 | 0.21000 | 0.03000 |
| GGGD | 0.12121 | 0.06439 | −0.18561 | −0.02273 | 0.03409 | −0.01136 |
| GGGN | −0.18000 | 0.07500 | 0.10500 | 0.09500 | 0.04000 | −0.13500 |
| GGGE | 0.21944 | −0.02500 | −0.19444 | −0.00278 | 0.05833 | −0.05556 |
| GGGQ | 0.18421 | 0.07895 | −0.26316 | −0.12829 | 0.25329 | −0.12500 |
| GGGK | 0.00490 | 0.05882 | −0.06373 | −0.19608 | −0.02696 | 0.22304 |
| GGGR | −0.18275 | 0.17105 | 0.01170 | 0.11404 | −0.11550 | 0.00146 |
| GGGH | −0.05833 | −0.02500 | 0.08333 | 0.56667 | −0.50833 | −0.05833 |
| GGGF | 0.06607 | 0.10179 | −0.16786 | 0.25179 | −0.28571 | 0.03393 |
| GGGY | −0.19565 | −0.07609 | 0.27174 | −0.05072 | 0.09058 | −0.03986 |
| GGGW | 0.06250 | −0.15625 | 0.09375 | −0.12500 | −0.03125 | 0.15625 |

In the left hand column, the first 20 tetrapeptide permutations are shown and the seven potential terms and six propensity terms are shown in the other columns

In some embodiments, the computer system 100 also includes a structure data module 180. The structure data module 180 receives protein structure data for mesophilic and thermophilic organisms from a protein structure database illustrated at 30. In one embodiment, the protein structure database includes a non-redundant set of protein structure data for proteins from mesophilic and thermophilic organisms. While high-resolution (e.g., better than 2.0 Å) structural data is not available for all of the sequences in the sequence database 10, inclusion of structure data allows the consideration of how stabilizing or destabilizing mutations affect protein folding and stability and increases the robustness of the predictive model.

When structure data are received by the structure data module 180 of the computing system, the data are transferred to the Delaunay module 190. The Delaunay module 190 of the computing system 100 divides the sequence data into all possible spatial combinations of amino acids. For example, the Delaunay module 190 may divide the structures into a series of four amino acid combinations; in contrast to the 20⁴ sequential combinations, there are only 8855 possible four amino acid spatial combinations of the 20 naturally occurring amino acids.

The output of the Delaunay module 190 is combined with the sequence data in the sequence data module 110 and fed to the combining module 140. In the combining module 140, the data are related to one another and combined into one data set. The output of the combining module is fed to the deriving module 150. The task of the deriving module 150 is to derive a set of spatial terms for each of the each of the amino acid combinations provided by the Delaunay module 190. The spatial terms derived by the deriving module 150 consist of 7 spatial features that include four potential terms and three propensity terms. The seven potential terms are related to occurrence (i.e., the potential that an amino acid combination exits) and a set of spatial terms that evaluate the potential that an amino acid combination is made up of amino acids that are sequentially related or sequentially isolated. The three propensity terms include a set of spatial terms that evaluate the likelihood that an amino acid combination is made up of amino acids that are sequentially related or sequentially isolated. The derivation of the potential and propensity terms is explained in greater detail in the Examples included herein. The derived terms are used to create a spatial protein stability lookup table that may be combined with the sequential protein stability lookup table.

The spatial terms derived by the deriving module 150 are combined with the sequential terms and fed to the fitting module 160, where the weights of the terms are fitted by referring back to the stability data module 120. Fitting the data according to the stability data in the stability data module 120 allows determining the relative weights of the terms of the spatial protein stability lookup table and the sequential protein stability lookup table. The output of the fitting module may be fed to an outputting module 170 a predictive model that includes the sequential and spatial terms and that may be used for calculating the thermal stability of a protein and/or for predicting mutations that stabilize a protein.

When structural data are included, the protein stability lookup table (see Table 1) further includes a table that includes the spatial terms described above. An example that includes of the first 20 lines of a protein stability lookup table that includes the seven spatial terms is shown below as Table 2.

TABLE 2

| DTwindow | pDTcounts | p43c | p2c | p1c | d43c | d2c | d1c |
|---|---|---|---|---|---|---|---|
| GGGG | 0.00363 | 0.00000 | −0.00175 | 0.00555 | 0.00000 | −0.00573 | 0.03435 |
| GGGA | 0.00654 | 0.00520 | 0.00825 | 0.00657 | −0.00125 | 0.00879 | −0.00143 |
| GGGV | 0.00847 | −0.00205 | −0.00289 | 0.01191 | −0.00638 | −0.03977 | 0.05385 |
| GGGL | 0.00813 | −0.01031 | −0.00723 | 0.01312 | −0.00940 | −0.05340 | 0.07565 |
| GGGI | 0.00796 | −0.00828 | 0.01150 | 0.00778 | −0.01390 | 0.02700 | −0.00830 |
| GGGS | −0.00083 | −0.01895 | 0.00092 | −0.00072 | −0.00630 | 0.00276 | 0.00618 |
| GGGT | 0.01271 | 0.05467 | 0.00188 | 0.01375 | 0.01702 | −0.02355 | 0.00652 |
| GGGC | −0.00819 | −0.01963 | −0.00942 | −0.00792 | −0.02294 | −0.09633 | 0.11927 |
| GGGM | −0.00059 | −0.02342 | 0.00129 | 0.00056 | −0.02422 | 0.01286 | 0.04729 |
| GGGP | 0.00442 | 0.03377 | 0.00006 | 0.00480 | 0.01365 | −0.01501 | 0.00438 |
| GGGD | 0.01332 | 0.00894 | 0.01169 | 0.01406 | −0.00142 | 0.00816 | −0.00182 |
| GGGN | 0.00003 | −0.00623 | 0.00002 | −0.00145 | −0.00280 | −0.00360 | 0.00640 |
| GGGE | 0.02348 | −0.03569 | 0.00762 | 0.02913 | −0.01693 | −0.02591 | 0.05641 |
| GGGQ | −0.00714 | −0.02342 | −0.00590 | −0.00605 | −0.01267 | −0.01445 | 0.05484 |
| GGGK | 0.01612 | 0.04269 | 0.00603 | 0.01867 | 0.01226 | −0.01724 | 0.02431 |
| GGGR | 0.01641 | −0.04256 | 0.01189 | 0.01875 | −0.02266 | −0.00046 | 0.02060 |
| GGGH | −0.00348 | −0.00644 | −0.00012 | −0.00428 | −0.00231 | 0.01404 | −0.01173 |
| GGGF | −0.00128 | −0.02083 | −0.00327 | 0.00076 | −0.01293 | −0.01705 | 0.05760 |
| GGGY | 0.00256 | 0.02471 | −0.00176 | 0.00276 | 0.01852 | −0.02169 | 0.00317 |
| GGGW | 0.00431 | −0.02585 | 0.00304 | 0.00591 | −0.03256 | −0.00160 | 0.06207 |

In the left hand column, the first 20 four amino acid combinations are shown and the four potential terms and three propensity terms are shown in the other columns. Thus, at least in some embodiments, the protein stability lookup table will include 13 sequential terms and 7 spatial terms.

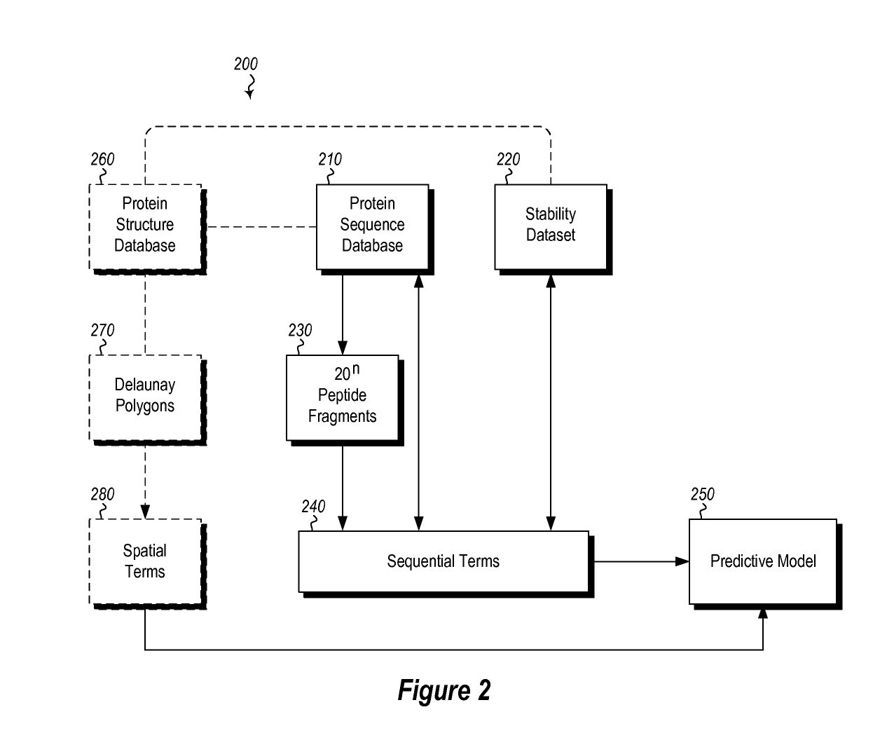

Referring now to FIG. 2, a flowchart illustrating a computer implemented method for generating a protein stability lookup table lookup table and a predictive model is illustrated. The protein stability lookup table can be generated at least in part by (i) providing a first protein sequence database 210 of thermophilic and mesophilic protein sequences, (ii) providing a stability dataset 220 of experimentally determined thermo-stability changes upon mutations for proteins and their mutants, (iii) dividing the thermophilic and mesophilic protein sequences in the first protein sequence database 210 into a series of 20ⁿ peptide fragments, (iv) deriving a plurality of sequential terms 240 for each of the 20ⁿ peptide fragments by combining and analyzing the first protein database 210 and the stability dataset 220 to generate the lookup table, and (iv) fitting the relative weights of the sequential terms using the stability dataset. The method further includes outputting 250 the predictive model that includes the sequential terms.

The predictive model may further include structural data for at least a subset of the thermophilic and mesophilic protein sequences in the first protein database 210 and the stability dataset 220. In such a case, the method further comprises combining a protein structure database 260 with the protein sequence data base 210, dividing the structural data into a combination of Delaunay polygons 270, deriving a plurality of spatial terms 280 based on the structural data 260 and the Delaunay polygons 270, combining the spatial terms 280 and the sequential terms 240, and fitting the relative weights of the spatial terms using the stability dataset. The method further includes outputting 250 the predictive model that includes the sequential and spatial terms.

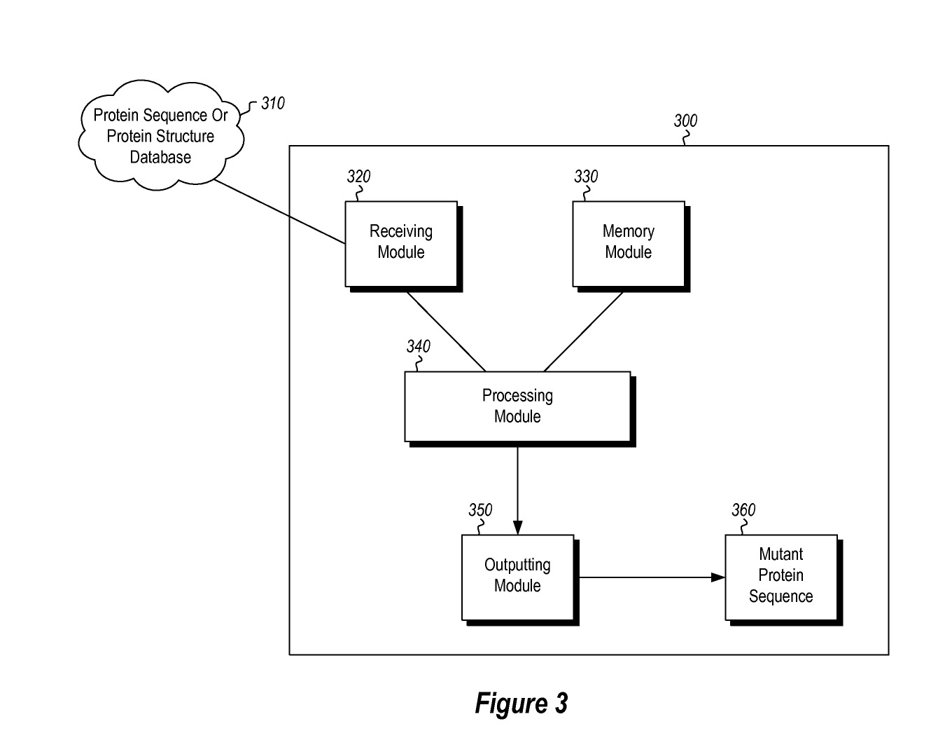

Referring now to FIG. 3, a computer system 300 that includes one or more processors, system memory, and one or more computer-readable storage media having stored thereon computer-executable instructions that, when executed by the one or more processors, causes the computing system to perform a method for determining one or more mutations for increasing the thermal stability of a protein. The computer system 300 includes a receiving module 320 that receives a base protein sequence or structure from the protein sequence or structure database 310 and a memory module 330 that has stored in a computer-readable medium a protein stability lookup table and a predictive model. The protein stability lookup table and a predictive model may be generated by the computer system described in FIG. 1 and/or it may be generated by the method described in FIG. 2.

The computer system 300 further includes a processing module 340 that receives inputs from the receiving module 320 and the memory module 330. One task of the processing module 340 is to divide the base protein sequence received from the receiving module 320 into all possible sequential multi-peptide fragments (e.g., tetrapeptide fragments) and determine a multitude of proposed mutations of the protein sequence. For example, the processing module 340 may propose substantially every possible mutation of the native protein sequence. In another example, the processing module 340 may propose a selected subset of mutations of the base protein sequence. Having divided the base sequence into all possible sequential multi-peptide fragments and having determined the proposed mutations, the processing module 340 then calculates the terms by comparing the fragments to the corresponding fragments of the lookup table. The predictive model predicts the relative stability score of the mutation based on a linear combination of these terms. The processing module can then rank the proposed mutations according to their relative stability score.

The ranked list is outputted by the processing module to the outputting module. According to at least one of programming parameters or user input, the outputting module can then output a mutant protein sequence 360 that has or is predicted to have an improved thermal stability.

In one embodiment, an improved thermal stability can be measured by an increase in the melting temperature (“Tm”) relative to the wild type. For example, a typical protein from a mesophilic organism may have a Tm of about 42° C. A mutant of that same protein with an improved thermal stability may have a Tm that is at least 2° C., 2.5° C., 3° C., 3.5° C., 4° C., 4.5° C., 5° C., 5.5° C., 6° C., 6.5° C., 7° C., 8° C., 9° C., or 10° C. greater. In another embodiment, the mutant with improved thermal stability may have a Tm that is 2.5-20° C. greater, 3-15° C. greater, 3.5-12° C. greater, 4-10° C. greater, or 5-9° C. greater.

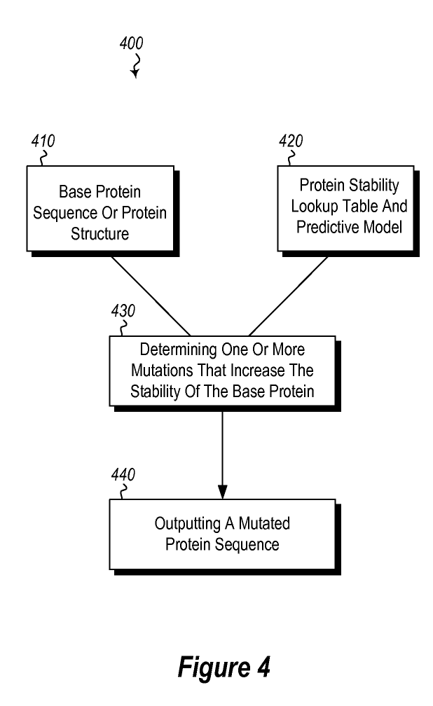

Referring now to FIG. 4, a method for determining one or more mutations for increasing the thermal stability of a protein is illustrated. The method includes (1) receiving into a computer system an amino acid sequence or structure of a base protein to be stabilized, (2) using a predictive model and a protein stability lookup table to determine one or more mutations for the amino acid sequence or structure that increases the thermal stability of the base protein, and (3) outputting a mutated protein sequence that has increased thermal stability relative to the base protein sequence.

As described above with respect to the computer system 300, using the predictive model and a protein stability lookup table to determine one or more mutations for the peptide sequence that increase the thermal stability of the protein is a multi-step process. The method includes (i) dividing the base protein sequence into all possible sequential multi-peptide fragments (e.g., tetrapeptide fragments). For example, for a first tetrapeptide fragment may include amino acids 1-4, a second may include amino acids 2-5, a third may include amino acids 3-6, and so on to the end of the protein chain. The method further includes (ii) determining a multitude of proposed mutations (e.g., substantially all possible mutations) of the native protein sequence, (iii) comparing the mutated multi-peptide fragments to the protein stability lookup table and the predictive model, (iv) scoring each of the proposed mutations in the context of their fragments by comparing the fragments to the corresponding fragments of the lookup table, and (v) outputting a mutated protein sequence that includes a subset of the proposed mutations and that has increased thermal stability relative to the base protein.

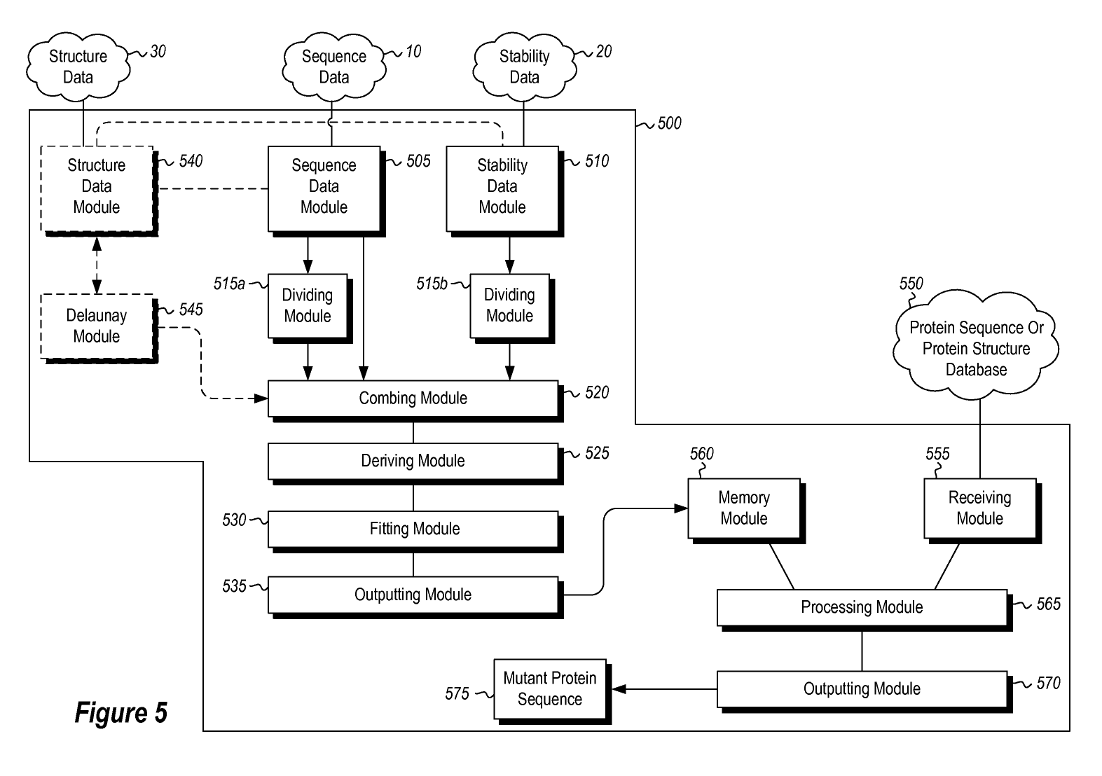

Referring now to FIG. 5, a computing system 500 for generating a protein stability lookup table and a predictive model, receiving a peptide sequence of a protein to be stabilized, using the predictive model and the protein stability lookup table to determine one or more mutations for the peptide sequence that increases the thermal stability of the protein, and outputting a mutated protein sequence is illustrated. The computing system 500 includes one or more processors, system memory, and one or more computer-readable storage media having stored thereon computer-executable instructions that, when executed by the one or more processors, causes the computing system to perform a method for making the computer program product.

In a first part (numbered elements 10-30 and 505-545) of the system 500, the protein stability lookup table and a predictive model are generated. The first part of the method is described in detail with respect to FIG. 1. The discussion of FIG. 1 is incorporated here by reference. In a second part (numbered elements 550-575) of the system 500, the protein stability lookup table and a predictive model are used to determine one or more mutations for the peptide sequence that increases the thermal stability of the protein, and output a mutated protein sequence. The second part of the computing system is described in detail with respect to FIG. 3. The discussion of FIG. 3 is incorporated here by reference.

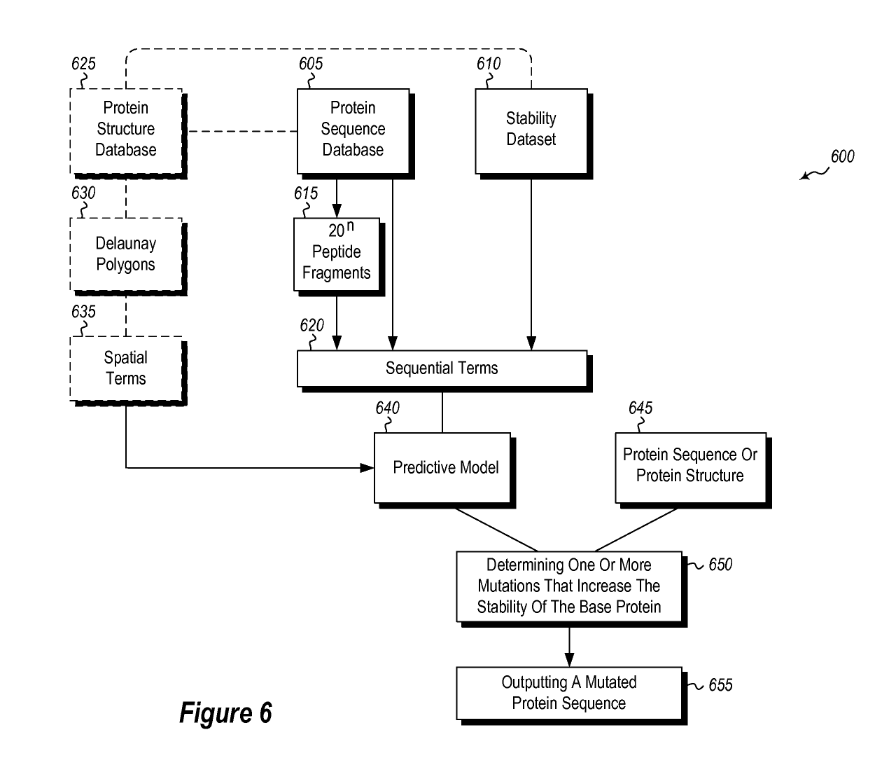

Referring now to FIG. 6, a method 600 for generating a protein stability lookup table and a predictive model, receiving a peptide sequence of a protein to be stabilized, using the predictive model and the protein stability lookup table to determine one or more mutations for the peptide sequence that increases the thermal stability of the protein, and outputting a mutated protein sequence is illustrated.

In a first part (numbered elements 605-635) of the method 600, the protein stability lookup table and a predictive model are generated. The first part of the method is described in detail with respect to FIG. 2. The discussion of FIG. 2 is incorporated here by reference. In a second part (numbered elements 640-655) of the method 600, the protein stability lookup table and a predictive model are used to determine one or more mutations for the peptide sequence that increases the thermal stability of the protein, and output a mutated protein sequence. The second part of the method is described in detail with respect to FIG. 4. The discussion of FIG. 4 is incorporated here by reference.

The following illustrates a non-limiting example of methods for carrying out various embodiments of the invention.

### Creating a Collection of Non-Redundant Thermophilic and Mesophilic Proteins Structures

1) A list of organisms with known optimal growth temperature (OGT) is collected from PGTdb [1], the UCSC archaea gnome database (http://archaea.ucsc.edu/), and other published literatures (e.g. [2, 3, 4, 5, 6, 7, 8]). Organisms with OGT of 50° C. or higher are considered as thermophiles. All remaining organisms, except those known as other types of extremophiles such as psychrophile, halophile, acidophile and alkaliphile, are considered as mesophiles.
2) All protein structures in Protein Data Bank (PDB, http://www.pdb.org) are downloaded and sorted into thermophilic and mesophilic proteins according to their source organisms defined in the previous step. The PDB entries without known source organisms are discharged. The PDB entries with chains from both thermophile and mesophile are also excluded. The protein structures are further filtered by R-factor (≦0.25) and resolution (≦2.0 Å) using PISCES [9].
3) Membrane proteins, according to a protein classification system such as SCOP [10], are removed. Chains with less than 50 residues or more than 800 residues are excluded.
4) To reduce the redundancy in the dataset, all remaining protein sequences are clustered using a clustering software program such as BLASTClust [11] and the longest chain in each cluster is kept. The sequence identity threshold is set to 30% and minimum length coverage is 0.9.
   The collection can be regularly updated in order to include newly determined protein structures in future.

### Creating a Non-Redundant Dataset of Experimentally Determined Thermo-Stability Changes Upon Mutations

Mutations with known melting temperatures (Tm) are collected from literature or databases such as Protherm [12]. Mutations with absolute ΔTm less than 1° C. are excluded because such small changes are probably not an experimentally detectable difference [13]. For mutations with multiple ΔTm values, the median ΔTm of these mutations is used if the sign of all ΔTm values is consistent, otherwise these mutations are excluded.

Mutations with known free energy changes (ΔΔG) are collected from literature such as [14].

The dataset can be updated when new data are available. Generally the more data, the more reliable the predictions. However, the improvement could be minimum once the dataset is sufficiently large.

### Hypothetical Reversed Mutations as Testing Datasets

A novel approach is developed to construct testing datasets by using hypothetical reversed mutations based on the fact that meting temperature (Tm) and the free energy are thermodynamic state functions. Therefore the Tm changes (ΔTm) and the free energy change (ΔΔG) of a mutation from a wild type protein to its mutant has the same value but an opposite sign with a mutation of these proteins in the reversed direction.

ΔTm_{Wt→Mu}=−ΔTm_{Mu→Wt} (1)

ΔΔG_{Wt→Mu}=−ΔΔG_{Mu→Wt} (2)

This approach is very useful in determining the robustness of predictive models.

### Secondary Structure and Solvent Accessibility Assignment

Software such as DSSP [15] is used to assign the secondary structure states and solvent accessible status of all residues in proteins. Each residue is assigned to one of the three classes of secondary structures (helix/strand/coil). Three levels of solvent accessibility are used: buried, intermediate and exposed residues. The solvent accessible area ratio (normalized by the max solvent accessible area of each amino acid) of a buried residue is less than 0.25 and an exposed residue is larger than 0.5. All others are assigned as intermediate residues.

### Creating a Four-Residue Based Thermo-Stability Potential (PROTS) Lookup Table

In one embodiment, one or more types of protein sequence fragments (e.g., four-residue fragments) can be used to calculate the PROTS potential. The first type includes all or a portion of the 20⁴ sequential tetrapeptides (abbreviated as SEQ), the full permutation of four amino acids. The other comprises the 8855 spatial Delaunay tetrahedra (“DT”) [16], the exhaustive combination of four amino acids. Table 3 illustrates the various spatial classes of residue clusters in the DTs and illustrates how the number 8855 is arrived at.

TABLE 3

| Class | | | | |
|---|---|---|---|---|
| 1 | C D E F | $( \begin{matrix}20 \\ 4\end{matrix} )$ | $\frac{20 !}{4 ! ( 20 - 4 ) !}$ | 4845 |
| 2 | C C D E | $20 \cdot ( \begin{matrix}19 \\ 2\end{matrix} )$ | $20 \cdot \frac{19 !}{2 ! ( 19 - 2 ) !}$ | 3420 |
| 3 | C C D D | $( \begin{matrix}20 \\ 2\end{matrix} )$ | $\frac{20 !}{2 ! ( 20 - 2 ) !}$ | 190 |
| 4 | C C C D | 20 · 19 | | 380 |
| 5 | C C C C | 20 | | 20 |
| | | | | 8855 |

In terms of the data analysis and classification into the lookup tables, three types of DTs are categorized according to the number of the continuously sequential residues in a Delaunay tetrahedron. Type D43 contains the DTs formed by at least three continuous residues. Type D2 contains at least one two-continuous-residue motif but not extended to three continuous residues. Type D1 is formed by four non-neighboring residues [16, 17, 18]. DTs with maximal edge less than 12 Å are included [19]. Since the structure of mutant is usually unavailable, we assume that a point mutation does not cause significant conformational changes and therefore the structures of mutants are created by simply replacing the wild type residues with mutation residues.

Each fragment in PROTS has 13 sequential features and 7 DT features. All features are used when the structure of the base protein is available. Only the sequential features are used if only sequence of the protein is available. The 13 sequential features include seven potential terms (calculated by Eq. 6) of dS(occurrence, Wᵢ), dS(helix, Wᵢ), dS(strand, Wᵢ), dS(coil, Wᵢ), dS(expose, Wᵢ), dS(bury, Wᵢ), dS(intermediate, Wᵢ) and six propensity terms from dD(helix, Wᵢ) to dD(intermediate, Wᵢ). The 7 DT features include dS(occurrence_DT, Wᵢ), dS(D43, Wᵢ), dS(D2, Wᵢ), dS(D1, Wᵢ) and the propensity terms dD(D43, Wᵢ), dD(D2, Wᵢ) and dD(D1, Wᵢ).

The occurrence probability of a given structural feature K (e.g. helix, strand, coil) for a fragment W, in a given training dataset X, P_{X}(K, Wᵢ), is calculated using Eq. 3:

$${P}_{X} ( K , {W}_{i} ) = \frac{{N}_{X} ( K , {W}_{i} )}{{\sum }_{i} {N}_{X} ( K , {W}_{i} )} \qquad ( 3 )$$

Here i runs over all possible four-residue fragments and N_{X}(K, Wᵢ) is the number of fragments Wᵢ for a feature K in a given dataset X. P_{X}(occurrence, Wᵢ) is the occurrence probability of the fragment Wᵢ in the dataset X. The propensity for the Wᵢ in the structure state indicated by feature K is defined as

$${D}_{X} ( K , {W}_{i} ) = \frac{{P}_{X} ( K , {W}_{i} )}{{P}_{X} ( occurrence , {W}_{i} )} \qquad ( 4 )$$

We also calculate the Shannon entropy of all fragments, defined as

S_{X}(K,Wᵢ)=−P_{X}(K,Wᵢ)ln P_{X}(K,Wᵢ) (5)

The potential contribution of a fragment Wᵢ, dS(K, Wᵢ), can be defined as:

dS(K,Wᵢ)=S_{T}(K,Wᵢ)−S_{M}(K,Wᵢ) (6)

Here T and M are the datasets of thermophilic and mesophilic proteins, respectively. Using Eq. 6, we calculate the potential contributions of all fragments from native protein structures. Similarly, we can calculate the propensity difference dD(K, Wᵢ). Shannon entropy is not used for propensities because they distribute over a small number of structural features while four-residue fragments distributed over a large number of types (>10³).

TP and MP orthologs are essentially mutants with multiple mutations of each other. Thus in principle TP/MP and mutation data are equivalent. Therefore both datasets may be integrated and used in PROTS.

In one embodiment, we classify all four-residue fragments involved in mutations into stabilizing or destabilizing fragments according to the thermo-stability changes caused by the mutations. The stabilizing (ST) fragments are those found in mutants in stabilizing mutations or from wild type proteins in destabilizing mutations. The destabilizing (DE) fragments are from mutants in destabilizing mutations or from wild type proteins in stabilizing mutations. The fragment based stability potential (PROTS) is calculated by

dS(K,Wᵢ)=S_{T}(K,Wᵢ)−S_{M}(K,Wᵢ)+δ_{ST}(Wᵢ)S_{T}(K)−δ_{DE}(Wᵢ)S_{M}(K) (7)

Here the first two terms are derived from native TP and MP structures and the last two terms are calculated from the point mutation dataset. S_{T}(K) and S_{M}(K) are the potential corresponding to the most popular four-residue fragments from thermophilic and mesophilic proteins, respectively. The factors δ_{ST}(Wᵢ) and δ_{DE}(Wᵢ) are used to address the thermo-stability preference of fragments based on the point mutation dataset:

$${δ}_{ST} ( {W}_{i} ) = \frac{{n}_{ST , Mu} ( {W}_{i} ) + {n}_{DE , Wt} ( {W}_{i} )}{\sum n ( {W}_{i} )} and {δ}_{DE} ( {W}_{i} ) = \frac{{n}_{ST , Wt} ( {W}_{i} ) + {n}_{DE , Mu} ( {W}_{i} )}{\sum n ( {W}_{i} )} \qquad ( 8 )$$

Here, the denominator is the total number of occurrence of a given fragment in the training dataset, Wt and Mu represent wild type proteins and mutants, respectively.

The thermo-stability potential P (i.e., stability factor) for a given protein was calculated through

$$P = - \frac{1}{L} \{ {\sum }_{i} {\sum }_{K} {α}_{K} d S ( K , {W}_{i} ) + {\sum }_{i} {\sum }_{K} {β}_{K} d D ( K , {W}_{i} ) \} \qquad ( 9 )$$

Here L is the number of residues in the protein, i runs over all possible sequential and DT fragments, and K includes all 13 sequential and/or 7 DT features.

Since the stability change equals to the relative stability difference between mutants and their wild type proteins, the PROTS potential change of a mutation can be calculated by

dP=P_{Mu}−P_{Wt} (10)

### Training Weights of Terms in the Lookup Table

The weights α_{K} and β_{K}, the relative contributions of various terms, for PROTS potential are optimized through maximizing the Pearson correlation coefficient between the predicted stability change ΔP and the experimental observed ΔTm values based on mutations in training set. The correlation coefficient R was defined as

$$R = \frac{\sum ( Δ S - < Δ S > ) ( Δ Tm - < Δ Tm > )}{sqrt \{ Var ( Δ S ) Var ( Δ Tm ) \}} \qquad ( 11 )$$

where the numerator is a summation over all mutations in the training dataset, < > and Var( ) are the mean value and the variance of the variable enclosed.

The lookup table and weights of terms in the table can be updated once the data they are built upon are updated.

### Creating the Features Used in the Random Forest Model (PROTS-RF) Model

We calculate 41 sequential and structural features. These features include the following four groups:
a) Evolutionary information: PSIBLAST can be used to search the wild type protein against the non-redundant (NR) protein sequences pre-filtered by sequence identity of 90% [20]. We consider the log-odds and weighted scores of the wild type residues and mutant residues, as well as the conservation of wild-type residues and neighboring residues enclosed in a window size of 5, 9 and 15 respectively. These values are directly extracted from the position specific scoring matrix (PSSM) for single point mutations. For multiple point mutations, the average of these values is used instead. Thus there are 10 parameters generated to record the evolutionary information for single or multiple mutations.
b) Secondary structure and solvent accessibility: Secondary structure and solvent exposure status of each residue are assigned based on the wild type proteins. If the structure of a wild-type protein is available, DSSP [15] is used instead to assign the secondary structures of all residues to three states: helix (H), extend (E) and coil (C); and solvent accessibility to exposed (e) or buried (b) using 25% relative accessible surface area as the cutoff threshold. When the wild-type protein structure is absent, Psipred [21] can be used to predict the secondary structures and SSpro [22] to predict accessibility of all residues. There were five features in this class.
c) Relative difference: We also utilize six relative differences of compositions and properties between the wild-type and the mutant sequences [23]. These six features include the change of positive charged residues, charged residues, small residues, tiny residues, maximum area of solvent accessibility (ASA) and the iso-electric point (pIa).
d) PROTS terms: As defined in previous sessions. The structure-based prediction provided 20 features include 13 sequential and 7 Delaunay tetrahedron based statistical terms.

### Building the Model

The predictive model may be built using Random Forest algorithm [24], an ensemble technique that utilizes many independent decision trees to perform classification or regression. The number of trees used in the model can be optimized by increasing the number until no obvious improvement is observed. In our test, two thousands of trees seem sufficient. The model can be updated if new data become available and features are updated. This invention utilizes the RandomForest package of R-project (http://cran.r-project.org/web/packages/randomForest/), but those skilled in the art will recognize that other implementations will work as well. Moreover, although Random Forest algorithm is used, many other algorithms can be used and the invention is not limited to a Random Forest algorithm. The unique aspect of the invention is the collection of features used.

### PROTS and PROTS-RF Implementation

PROTS and PROTS-RF can be implemented as software programs in a computer system. The software programs can be written in programming languages such as Perl. They may run through a command line console, a graphic user interfaces or web-browser based interfaces.

### PROTS and PROTS-RF Applications

PROTS and PROTS-RF can be used either independently or jointly (using either Boolean AND or OR operations). There are at least two ways both methods can be applied: a). identify single or multiple mutations for a given base protein sequence; b) predict relative stability of several proteins (related or unrelated).

The goal of identifying single or multiple mutations for a given base protein sequence is to develop more stable mutants of the base protein without losing its function and activity. The process includes an optional step of generating a list of allowable substitutions; using PROTS and/or PROTS-RF to predict protein stability potential changes of each allowable substitution and select those with greatest increases. The optional step of generating a list of allowable substitutions can be done by comparing the base protein sequence to a large non-redundant protein database using software programs such as BLAST. Well conserved residues are considered important for the protein's function and activity, therefore they are not subjected to mutations. The cutoff of conservation level is adjustable so the number of allowable substitutions will change accordingly.

PROTS and PROTS-RF can choose favorable mutations, the PROTS potentials and PROTS-RF predicted values are highly correlated to the experimentally determined Tm and ΔΔG changes. Therefore both methods can be used qualitatively and quantitatively.

The present invention can also be used to compare the relative stability of any number of proteins (wild types and/or mutants). In this case, PROTS stability potentials for all proteins are calculated and ranked accordingly.

Comparing the Prediction Performance PROTS and PROTS-TS with Other Algorithms

Extensive comparative studies have been conducted to validate the advantage of PROTS and PROTS-RF over other existing algorithms (Table 4-5). In all cases, PROTS and PROTS-RF have shown very good performance. Both are very robust when hypothetical mutant to wild type mutation data are used. Many other methods are not expected to succeed in this test because of the ways they are developed.

TABLE 4
Comparison of prediction of stability change
(ΔTm) by PROTS with other algorithms.

| | | | Hypothetical | |
|---|---|---|---|---|
| | Wild type | | mutant to wild | |
| | to mutant | | type | |
| Algorithm | AUC^{a} | R^{b} | AUC | R |
| MUpro[25] | 0.828 | 0.566 | 0.506 | 0.063 |
| (comparative) | | | | |
| I-Mutant2.0[26] | 0.849 | 0.563 | 0.558 | 0.098 |
| (comparative) | | | | |
| LSE[27] | 0.578 | 0.145 | 0.578 | 0.145 |
| (comparative) | | | | |
| PROTS (with | 0.890 | 0.438 | 0.890 | 0.438 |
| structure) | | | | |
| PROTS (sequence | 0.884 | 0.419 | 0.884 | 0.419 |
| only) | | | | |

^{a}AUC: area under Receiver operating characteristic. A metric commonly used to measure performance of predictive models. AUC of a perfect model is 1. AUC of a random model is 0.5. The bigger the number, the better the performance is.
^{b}R: correlation coefficient of regression model.

TABLE 5
Comparison the ΔΔG prediction performance for mutations
and hypothetical reversed mutations. Mutations identical to
the ones used in training were excluded for all algorithms.

| | Wild type | | Hypothetical mutant | |
|---|---|---|---|---|
| | to mutant | | to wild type | |
| Methods | AUC^{a} | R^{b} | AUC^{a} | R^{b} |
| MUpro (comparative) | 0.687 | 0.483 | 0.564 | 0.167 |
| I-Mutant2.0 (comparative) | 0.694 | 0.540 | 0.557 | 0.069 |
| LSE (comparative) | 0.577 | 0.155 | 0.577 | 0.155 |
| FoldX ^{a} (Comparative) | 0.738 | 0.497 | — | — |
| EGAD ^{a} (Comparative) | 0.745 | 0.595 | — | — |
| PROTS (with structure) | 0.819 | 0.402 | 0.819 | 0.402 |
| PROTS (sequence only) | 0.815 | 0387 | 0.815 | 0.387 |
| PROTS-RF (with Structure) | 0.869 | 0.620 | 0.858 | 0.616 |
| PROTS-RF (sequence only) | 0.873 | 0.628 | 0.863 | 0.622 |

^{a}AUC: area under Receiver operating characteristic. A metric commonly used to measure performance of predictive models. AUC of a perfect model is 1. AUC of a random model is 0.5. The bigger the number, the better the performance is.
^{b}R: correlation coefficient of regression model.

### Experimental Testing

The methods of the invention were used in developing a stable ricin vaccine (Example 1). One of the two predicted mutations (S228K, Mut_{—}6 in Table 1) resulted in a mutant with melting temperature 6.2 degrees higher than the wild type vaccine. As comparison, the best of the five mutants predicted using a leading competitive method has a melting temperature 1.9 degrees higher than the wild type vaccine (Table 6).

TABLE 6
Experimental validation of PROTS predictions.

| | | Other Method (comparative) | | | | | Example 1 | |
|---|---|---|---|---|---|---|---|---|
| | Wild type/mutant | | | | | | | |
| | Wild type | Mut_1 | Mut_2 | Mut_3 | Mut_4 | Mut_5 | Mut_6 | Mut_7 |
| Melting | 42.3 | 43.6 | 41.9 | 41.2 | 44.2 | 42.6 | 48.5 | 41.5 |
| Temp. (° C.) | | | | | | | | |

Embodiments of the present invention may comprise or utilize a special purpose or general-purpose computer including computer hardware, such as, for example, one or more processors and system memory. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions are computer storage media (devices). Computer-readable media that carry computer-executable instructions are transmission media. Thus, by way of example, and not limitation, embodiments of the invention can comprise at least two distinctly different kinds of computer-readable media: computer storage media (devices) and transmission media.

Computer storage media (devices) includes RAM, ROM, EEPROM, CD-ROM, DVD, or other optical disk storage, magnetic disk storage or other magnetic storage devices, or any other medium which can be used to store desired program code means (software) in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry or desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to computer storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that computer storage media (devices) can be included in computer system components that also (or even primarily) utilize transmission media.

Computer-executable instructions comprise, for example, instructions and data which, when executed at a processor, cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

### REFERENCES

1. Huang S L, Wu L C, Liang H K, Pan K T, Horng T T, et al. (2004) PGTdb: a database providing growth temperatures of prokaryotes. Bioinformatics 20: 276-278.
2. Zeldovich K B, Berezovsky I N, Shakhnovich E I (2007) Protein and DNA sequence determinants of thermophilic adaptation. PLoS Comput Biol 3: 62-72.
3. Puigbo P, Pasamontes A, Garcia-Vallve S (2008) Gaining and losing the thermophilic adaptation in prokaryotes. Trends Genet 24: 10-14.
4. Heinzelman P, Snow C D, Wu I, Nguyen C, Villalobos A, et al. (2009) A family of thermostable fungal cellulases created by structure-guided recombination. Proc Natl Acad Sci USA 106: 5610-5615.
5. Trivedi S, Gehlot H S, Rao S R (2006) Protein thermo-stability in Archaea and Eubacteria. Genet Mol Res 5: 816-827.
6. Stetter K O (2006) History of discovery of the first hyperthermophiles. Extremophiles 10: 357-362.
7. Laksanalamai P, Robb F T (2004) Small heat shock proteins from extremophiles: a review. Extremophiles 8: 1-11.
8. Sterner R, Liebl W (2001) Thermophilic adaptation of proteins. Crit Rev Biochem Mol Biol 36: 39-106.
9. Wang G, Dunbrack R L, Jr. (2003) PISCES: a protein sequence culling server. Bioinformatics 19: 1589-1591.
10. Murzin A G, Brenner S E, Hubbard T, Chothia C (1995) SCOP: a structural classification of proteins database for the investigation of sequences and structures. J Mol Biol 247: 536-540.
11. Altschul S F, Gish W, Miller W, Myers E W, Lipman D J (1990) Basic local alignment search tool. J Mol Biol 215: 403-410.
12. Kumar M D, Bava K A, Gromiha M M, Prabakaran P, Kitajima K, et al. (2006) ProTherm and ProNIT: thermodynamic databases for proteins and protein-nucleic acid interactions. Nucleic Acids Res 34: D204-206.
13. Li Y, Drummond D A, Sawayama A M, Snow C D, Bloom J D, et al. (2007) A diverse family of thermostable cytochrome P450s created by recombination of stabilizing fragments. Nat Biotechnol 25: 1051-1056.
14. Potapov V, Cohen M, Schreiber G (2009) Assessing computational methods for predicting protein stability upon mutation: good on average but not in the details. Protein Eng Des Sel 22: 553-560.
15. Kabsch W, Sander C (1983) Dictionary of protein secondary structure: pattern recognition of hydrogen-bonded and geometrical features. Biopolymers 22: 2577-2637.
16. Singh R K, Tropsha A, Vaisman, I I (1996) Delaunay tessellation of proteins: four body nearest-neighbor propensities of amino acid residues. J Comput Biol 3: 213-221.
17. Liang J, Edelsbrunner H, Woodward C (1998) Anatomy of protein pockets and cavities: measurement of binding site geometry and implications for ligand design. Protein Sci 7: 1884-1897.
18. Masso M, Vaisman, I I (2007) Accurate prediction of enzyme mutant activity based on a multibody statistical potential. Bioinformatics 23: 3155-3161.
19. Deutsch C, Krishnamoorthy B (2007) Four-body scoring function for mutagenesis. Bioinformatics 23: 3009-3015.
20. Altschul S F, Madden T L, Schaffer A A, Zhang J, Zhang Z, et al. (1997) Gapped BLAST and PSI-BLAST: a new generation of protein database search programs. Nucleic Acids Res 25: 3389-3402.
21. McGuffin L J, Bryson K, Jones D T (2000) The PSIPRED protein structure prediction server. Bioinformatics 16: 404-405.
22. Cheng J, Randall A Z, Sweredoski M J, Baldi P (2005) SCRATCH: a protein structure and structural feature prediction server. Nucleic Acids Res 33: W72-76.
23. Li Y, Middaugh C R, Fang J (2010) A novel scoring function for discriminating hyperthermophilic and mesophilic proteins with application to predicting relative thermo-stability of protein mutants. BMC Bioinformatics 11: 62.
24. Breiman L (2001) Random Forests. Machine Learning 45: 5-32.
25. Cheng J, Randall A, Baldi P (2006) Prediction of protein stability changes for single-site mutations using support vector machines. Proteins 62: 1125-1132.
26. Capriotti E, Fariselli P, Casadio R (2005) I-Mutant2.0: predicting stability changes upon mutation from the protein sequence or structure. Nucleic Acids Res 33: W306-310.
27. Chan C H, Liang H K, Hsiao N W, Ko M T, Lyu P C, et al. (2004) Relationship between local structural entropy and protein thermo-stability. Proteins 57: 684-691.
   The entireties of each of the above references are hereby incorporated by this reference.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A method for making a computer program product for predicting mutations that stabilize a protein, comprising:
(i) providing a first protein database of thermophilic and mesophilic protein sequences;
(ii) providing a stability dataset of experimentally determined thermo-stability changes upon mutations for proteins and their mutants;
(iii) dividing the thermophilic and mesophilic protein sequences into a series of 20ⁿ peptide fragments, where 20 is the number of different amino acids and n is the number of amino acids in the peptide fragments;
(iv) deriving a plurality of sequential terms for each of the 20ⁿ peptide fragments by combining and analyzing the first protein database and the stability dataset; and
(iv) fitting the relative weights of the sequential terms using the stability dataset.

2. The method of claim 1, wherein the first protein database further includes structural data for at least a subset of the thermophilic and mesophilic protein in the first protein database and the stability dataset, and the method further comprising:
deriving a plurality of spatial terms based on the structural data; and
fitting the relative weights of the spatial terms using the stability dataset.

3. The method of claim 2, wherein the sequential terms and the spatial terms include a series of potential terms and propensity terms selected to provide a thermo-stability potential estimate for each of the 20ⁿ peptide fragments.

4. The method of claim 1, wherein at least a portion of the mutations are single point mutations.

5. The method of claim 4, wherein at least a portion of the mutations are destabilizing mutations.

6. The method of claim 5, wherein identifying stabilizing or destabilizing mutations includes selecting proteins to be compared based on evolutionary information.

7. The method of claim 1, wherein at least a portion of the sequential terms are derived in part by comparing the sequences of the mesophilic and thermophilic sequences and identifying stabilizing or destabilizing mutations.

8. The method of claim 1, wherein the peptide fragments are four amino acid residues in length (i.e., tetra peptides).

9. The method of claim 1, further comprising:
providing at least one predictive model;
providing a new protein sequence having an unknown thermo-stability; and
calculating a thermo-stability potential for the new protein sequence based on the at least one predictive model.

10. The method of claim 9, further comprising using the at least one predictive model and the computer program product to determine one or more mutations for the peptide sequence that increase the thermo-stability of the protein.

11. The method of claim 1, wherein the computer program product for predicting mutations that stabilize a protein includes a computing system, the computing system including:
one or more processors;
system memory; and
one or more computer-readable storage media having stored thereon computer-executable instructions that, when executed by the one or more processors, causes the computing system to perform the method of claim 1.

12. A computer system comprising the following:
one or more processors;
system memory; and
one or more computer-readable storage media having stored thereon computer-executable instructions that, when executed by the one or more processors, causes the computing system to perform a method for determining one or more mutations for increasing the thermal stability of a protein, the method comprising:
receiving into the computer system an amino acid sequence of a protein to be stabilized; and
using a protein stability lookup table and at least one predictive model calculated based on the protein stability lookup table to determine one or more mutations for the peptide sequence that increases the thermal stability of the protein, the protein stability lookup table including 20ⁿ unique peptide fragment sequences each having a thermal stability factor associated therewith, where 20 is the number of naturally occurring amino acids and n is the number of amino acids in each of the unique peptide fragments.

13. The computer system of claim 12, wherein n=4 and the protein stability potential lookup table includes 20⁴ (i.e., 160,000) unique peptide fragment sequences.

14. The computer system of claim 12, wherein at least a portion of the thermal stability factors are derived from a change in stability of a protein having one or more stabilizing or destabilizing mutations.

15. The computer system of claim 14, wherein at least a portion of the thermal stability factors for the peptide fragments are derived from a difference in thermal stability of one or more associated peptide fragments between a thermophilic protein and a mesophilic ortholog thereof.

16. The computer system of claim 12, wherein thermal stability factors for each of the unique peptide fragment sequences of the protein stability potential lookup table are derived from a combination and analysis of protein sequences of mesophilic and thermophilic organisms.

17. The computer system of claim 16, wherein thermal stability factors for each of the unique peptide fragment sequences of the protein stability potential lookup table are further derived from a combination and analysis of protein structure data from proteins of mesophilic and thermophilic organisms.

18. A method for predicting mutations that increase protein stability, the method comprising:
providing a computing system having a protein stability potential lookup table that includes 20⁴ unique peptide fragment sequences each having a thermal stability factor associated therewith and a predictive model calculated based on the protein stability lookup table, wherein the protein stability potential lookup table and a predictive model are derived from a combination and analysis of protein sequences from mesophilic and thermophilic organisms;
inputting into the computing system an amino acid sequence that defines a base protein;
determining a multitude of proposed mutations of the amino acid sequence;
assigning a relative thermo-stability potential to each of the multitude of proposed mutations based on the protein stability potential lookup table and the predictive model; and
outputting from the computing system a mutant protein sequence that defines a mutant protein that is more thermally stable than the base protein, wherein the mutant protein sequence includes a subset of stabilizing mutations selected from the multitude of proposed mutations.

19. The method of claim 18, wherein the inputting step includes:
dividing the native protein sequence into a series of tetrapeptide fragments, wherein the native protein sequence includes n amino acids and the tetrapeptides include amino acids 1-4, 2-5, 3-6, . . . n; and
wherein the multitude of proposed mutations includes substantially all possible mutations of each of the n amino acids in each of the series of tetrapeptide fragments.

20. The method of claim 19, wherein the predictive model assigns helix feature, an extend feature, and/or a coil feature potential and propensity terms for each of the tetrapeptide fragments.

21. The method of claim 18, wherein at least a portion of the stabilizing mutations are synergistic.

22. The method of claim 18, wherein the predictive model assigns solvent accessibility to exposed, intermediate and/or buried residues of the protein using 25% and 50% relative accessible surface area as cutoff thresholds.

23. The method of claim 18, wherein the predictive model includes a Random Forest algorithm.
